(19) United States
(12) Patent Application Publication
(10) Pub. No.: US 2026/0357466 A1
(43) Pub. Date: Nov. 12, 2026

(54) COMPOSITE PLATING SOLUTION, PREPARATION METHOD OF COMPOSITE PLATING LAYER, AND ELECTRIC CONTACT MATERIAL

(71) Applicant: ZHEJIANG CHINT ELECTRICS CO., LTD., Wenzhou, Zhejiang (CN)

(72) Inventors: Junyu LIN, Wenzhou, Zhejiang (CN); Zhengli XU, Wenzhou, Zhejiang (CN); Yu XIANG, Wenzhou, Zhejiang (CN); Qi SHEN, Wenzhou, Zhejiang (CN)

(73) Assignee: ZHEJIANG CHINT ELECTRICS CO., LTD., Wenzhou, Zhejiang (CN)

(21) Appl. No.: 18/997,049

(22) PCT Filed: Nov. 13, 2023
(86) PCT No.: PCT/CN2023/131189

§ 371 Date: Jan. 18, 2025

(30) Foreign Application Priority Data
Nov. 18, 2022 (CN) 202211447644.6

(51) Int. Cl. C25D 3/46

(52) U.S. Cl. CPC C25D 3/46

(57) ABSTRACT

Disclosed herein are a composite plating solution, a method for preparing a composite plating layer, and an electric contact material. The composite plating solution includes a water-soluble silver-containing compound, a cyanide, graphene, a rare earth oxide, a dispersing agent, a wetting agent, and water. The rare earth oxide includes at least one of lanthanum oxide, yttrium oxide, or cerium oxide. The disclosure aims to solve a problem of poor welding resistance of an existing silver plating layer.

This disclosure claims priority to Chinese Patent Application No. 202211447644.6, filed on Nov. 18, 2022, entitled “COMPOSITE PLATING SOLUTION, PREPARATION METHOD OF COMPOSITE PLATING LAYER, AND ELECTRIC CONTACT MATERIAL”, the entire disclosure of which is incorporated herein by reference.

### TECHNICAL FIELD

The present disclosure relates to plating solutions, and more particularly, to a composite plating solution, a method for preparing a composite plating layer, and an electric contact material.

### BACKGROUND

Electric contact materials are core components and materials of electrical switches, which are responsible for turning on and off of circuits and load currents, and their performance determines the switching capacity and contact reliability of electrical switches.

To ensure good electric conductivity, the electric contact material is typically plated with a silver plating layer on a surface of the substrate.

### Technical Problems

The silver plating layer of the related art is low in hardness and poor in welding resistance, and it is difficult to meet the practical needs of rapidly developing electrical equipment.

### Technical Solutions

The present disclosure provides a composite plating solution, a method for preparing a composite plating layer, and an electric contact material, which can solve a problem of poor welding resistance of an existing silver plating layer.

In a first aspect, the present disclosure provides a composite plating solution including a water-soluble silver-containing compound, a cyanide, graphene, a rare earth oxide, a dispersing agent, a wetting agent, and water. The rare earth oxide includes at least one of lanthanum oxide, yttrium oxide, or cerium oxide.

Alternatively, in some embodiments of the present disclosure, a weight ratio of the graphene to the rare earth oxide is 1:1.2 to 3.

Alternatively, in some embodiments of the present disclosure, the rare earth oxide has a particle size of 10 to 120 nm.

Alternatively, in some embodiments of the present disclosure, the rare earth oxide includes yttrium oxide and lanthanum oxide in a weight ratio of 1:7 to 9.

Alternatively, in some embodiments of the present disclosure, the rare earth oxide includes yttrium oxide and cerium oxide in a weight ratio of 1:6 to 8.

Alternatively, in some embodiments of the present disclosure, the rare earth oxide includes yttrium oxide, cerium oxide and lanthanum oxide in a weight ratio of 1:1 to 1.5:5 to 8.

Alternatively, in some embodiments of the present disclosure, the wetting agent includes at least two of 1,3,6-naphthalene trisulfonate sodium salt, lignosulfonate, or alkyl sulfosuccinate.

Alternatively, in some embodiments of the present disclosure, the dispersing agent includes at least one of a naphthol sulfonic acid formalin condensate sodium salt, a naphthalene sulfonic acid formalin condensate sodium salt, a carboxylic acid-styrene sulfonic acid copolymer sodium salt, sodium dialkyl sulfosuccinate, sodium lauryl sulfate, a polyoxyethylene alkyl aryl ether.

Alternatively, in some embodiments of the present disclosure, a concentration of silver ions of the silver-containing compound in the composite plating solution is 5 to 10 g/L.

Alternatively, in some embodiments of the present disclosure, a concentration of the graphene in the composite plating solution is 0.3 to 0.8 g/L.

Alternatively, in some embodiments of the present disclosure, a concentration of the rare earth oxide in the composite plating solution is 0.36 to 2.4 g/L.

Alternatively, in some embodiments of the present disclosure, a concentration of the dispersing agent in the composite plating solution is 0.3 to 3.5 g/L.

Alternatively, in some embodiments of the present disclosure, a concentration of the cyanide in the composite plating solution is 90 to 210 g/L; and/or,
the cyanide includes at least one of potassium cyanide or sodium cyanide.

Alternatively, in some embodiments of the present disclosure, a concentration of the wetting agent in the composite plating solution is 0.3 to 2 g/L; and/or,
a pH of the composite plating solution is 7.5 to 10.5.

Alternatively, in some embodiments of the present disclosure, a weight ratio of the wetting agent to the dispersing agent in the composite plating solution is 1:1 to 2.

Alternatively, in some embodiments of the present disclosure, the composite plating solution is composed of the water-soluble silver-containing compound, the cyanide, the graphene, the rare earth oxide, the dispersing agent, the wetting agent, and water, and the rare earth oxide is composed of at least one of lanthanum oxide, yttrium oxide, or cerium oxide; and/or,
in the composite plating solution, the concentration of the silver ions is 5 to 10 g/L, the concentration of the graphene is 0.3 to 0.8 g/L, the concentration of the rare earth oxide is 0.36 to 2.4 g/L, the concentration of the wetting agent is 0.3 to 2 g/L, the concentration of the dispersing agent is 0.3 to 3.5 g/L, the concentration of the cyanide is 90 to 210 g/L; the pH of the composite plating solution is 7.5 to 10.5; and the weight ratio of the graphene to the rare earth oxide is 1:1.2 to 3.

In a second aspect, the present disclosure provides a method for preparing a composite plating layer including:
providing a substrate and a composite plating solution as described above;
electroplating a surface of the substrate with the composite plating solution to obtain the composite plating layer.

Alternatively, in some embodiments of the present disclosure, a temperature of the composite plating solution during the electroplating is 16 to 24 °C.

Alternatively, in some embodiments of the present disclosure, a current density during the electroplating is 0.3 to 0.7 A/dm².

In a third aspect, the present disclosure also provides an electric contact material including a substrate and a composite plating layer coated on a surface of the substrate, the composite plating layer including the composite plating layer as described above, or the composite plating layer prepared by the method as described above.

### Beneficial Effect

According to the technical solutions of the present disclosure, the composite plating solution includes the water-soluble silver-containing compound, the cyanide, the graphene, the rare earth oxide, the dispersing agent, the wetting agent, and water. By adding the graphene and the rare earth oxide, the composite plating layer prepared by the composite plating solution can not only have excellent performances such as electric conductive, wear resistance, hardness, and welding resistance, but also correspondingly reduce the amount of silver, thereby reducing the cost. Meanwhile, the rare earth oxide includes at least one of lanthanum oxide, yttrium oxide, or cerium oxide, and by selecting the rare earth oxide that matches the graphene and other components, the rare earth oxide can be stably present in the plating solution. By adding the dispersing agent and the wetting agent, the graphene and the rare earth oxide are assisted to be stably and uniformly dispersed in the plating solution, thereby giving full play to respective excellent characteristics.

### BRIEF DESCRIPTION OF THE DRAWINGS

The technical solutions in the embodiments of the present disclosure may be explained more clearly in conjunction with the accompanying drawings for the description of the embodiments. It will be apparent that the accompanying drawings in the following description are merely some of the embodiments of the present disclosure, and other drawings may be made to those skilled in the art based on these drawings without involving any inventive effort.

FIG. 1 is a schematic flowchart of a method for preparing a composite plating layer according to some embodiments of the present disclosure.

### DETAILED DESCRIPTION OF THE EMBODIMENTS

The embodiments of the present disclosure will be clearly and fully in connection with the accompanying drawings in the embodiments of the present disclosure. It will be apparent that the described embodiments are merely a part, rather than all of the embodiments. All other embodiments obtained by a person skilled in the art based on the embodiments in the present disclosure, without involving any inventive effort, fall within the scope of the present disclosure. Furthermore, it is to be understood that the specific embodiments described herein are for purposes of illustration and explanation only and are not intended to limit the disclosure. In the present disclosure, in the absence of a contrary indication, the terms “up” and “down” are used to refer specifically to the orientation of the drawings in the accompanying drawings. Furthermore, in the description of the present disclosure, the term “include”, “including”, “comprise”, or “comprising” means “including but not limited to”. Various embodiments of the present disclosure may be presented in a range format. It is to be understood that the description in range format is merely for convenience and brevity and should not be construed as an inflexible limitation on the scope of the disclosure. Accordingly, the description of a range is to be considered to have specifically disclosed all the possible subranges as well as individual numerical values within that range. For example, description of a range such as from 1 to 6 is to be considered to have specifically disclosed subranges such as from 1 to 3, from 1 to 4, from 1 to 5, from 2 to 4, from 2 to 6, from 3 to 6 or the like, as well as individual numbers within that range, for example, 1, 2, 3, 4, 5, and 6. This applies regardless of the breadth of the range. Whenever a numerical range is indicated herein, it is meant to include any cited numeral (fractional or integral) within the indicated range.

In the present disclosure, “and/or”, describing an associative relationship of the listed objects, indicates three relationships. For example, the term “A and/or B” can indicate A alone, both A and B, and B alone. A and B can be singular or plural.

In the present disclosure, the term “at least one of” refers to one or more, and “multiple” or “a plurality of” refers to two or more. The term “at least one of”, “at least one of the following” or the like, refers to any combination of related listed items, including any single related listed item or any combination of multiple related listed items. For example, “at least one of a, b, or c” or “at least one of a, b, and c” may all mean a, b, c, a-b (i.e., a and b), a-c, b-c, or a-b-c, in which a, b, and c respectively may be singular or plural.

Embodiments of the present disclosure provide a composite plating solution, which is can be used to prepare a composite plating layer. The composite plating solution includes a water-soluble silver-containing compound, a cyanide, the graphene, a rare earth oxide, a dispersing agent, a wetting agent, and water, wherein the rare earth oxide includes at least one of lanthanum oxide, yttrium oxide, or cerium oxide.

The composite plating solution according to the present disclosure includes a water-soluble silver-containing compound, a cyanide, the graphene, a rare earth oxide, a dispersing agent, a wetting agent, and water, wherein the graphene has excellent properties such as high electric conductivity, high heat conductivity, high strength, high flexibility, strong chemical inertness, and the like, so that the composite plating solution can improve the arc extinction property, welding resistance, wear resistance, and hardness of the composite plating layer by adding the graphene, and enhance the welding resistance and hardness by adding the rare earth oxides. In general, the present composite plating solution has excellent electric conductivity, wear resistance, hardness, and welding resistance properties. In addition, due to the addition of the graphene with high electric conductivity, the amount of silver is correspondingly reduced, thereby reducing the cost.

The graphene has poor dispersibility and is easy to agglomerate in water, so that it is difficult to give full play to its properties. Meanwhile, the stability of the composite plating solution is poor, and the introduction of each additional component will cause a decrease in the stability of the plating solution, leading to decomposition, toxicity and other phenomena in the plating solution. In view of the above problems, in one aspect of the present disclosure, rare earth oxides matched to the graphene and other components are selected so that both the graphene and the rare earth oxides can be stably present in the plating solution. On the other hand, by adding the dispersing agent and the wetting agent, the graphene and the rare earth oxides are stably and uniformly dispersed in the plating solution, and are deposited onto a surface of the substrate during the electroplating to form the plating layer which is uniformly distributed, so that the excellent characteristics of each of the two materials are fully realized, and the performance of the composite plating layer is improved.

In some embodiments, the rare earth oxide is yttrium oxide and lanthanum oxide in a weight ratio of 1:7 to 9. For example, the weight ratio of yttrium oxide to lanthanum oxide may be 1:7, 1:7.2, 1:7.5, 1:8, 1:8.5, 1:8.7, 1:9, or the like. By controlling the mixing ratio of the rare earth oxides, the rare earth oxides, the graphene and the silver ions can be well matched, and the yttrium oxide and the lanthanum oxide can give full play to their excellent properties while ensuring the stability of the composite plating solution, thereby improving the hardness and the welding resistance of the composite plating layer.

In other embodiments, the rare earth oxide is yttrium oxide and cerium oxide in a weight ratio of 1:6 to 8. For example, the weight ratio of yttrium oxide to lanthanum oxide may be 1:6, 1:6.5, 1:7, 1:7.2, 1:7.5, 1:8, or the like. By controlling the mixing ratio of the rare earth oxides, the rare earth oxides, the graphene and the silver ions can be well matched, and the yttrium oxide and the cerium oxide can give full play to their excellent properties while ensuring the stability of the composite plating solution, thereby improving the hardness and the welding resistance of the composite plating layer.

In still other embodiments, the rare earth oxide is yttrium oxide, cerium oxide, and lanthanum oxide in a weight ratio of 1:1 to 1.5:5 to 8. For example, the weight ratio of yttrium oxide, cerium oxide, and lanthanum oxide may be 1:1:5, 1:1.2:5, 1:1.5:5, 1:1:6, 1:1:7, 1:1:8, 1:1.5:6, 1:1.5:7, 1:1.5:8, or the like. By controlling the mixing ratio of the rare earth oxides, the rare earth oxides, the graphene, and the silver ions can be well matched, and the yttrium oxide, the cerium oxide, and the lanthanum oxide can give full play to their excellent properties while ensuring the stability of the composite plating solution, thereby improving the hardness and the welding resistance of the composite plating layer.

In some embodiments, the concentration of the graphene is 0.3 to 0.8 g/L, for example, 0.3 g/L, 0.5 g/L, 0.6 g/L, 0.7 g/L, 0.8 g/L, or the like. In this range, it helps to increase the content of the graphene in the composite plating layer, and to improve the electric conductivity, arc extinction property, welding resistance, wear resistance, and hardness of the plating layer.

In some embodiments, the weight ratio of the graphene to the rare earth oxide is 1:1.2 to 3, for example, 1:1.2, 1:1.3, 1:1.5, 1:1.7, 1:2, 1:2.2, 1:2.5, 1:2.8, 1:3, or the like. According to the present embodiments, the graphene and the rare earth oxide are mixed in suitable proportions to help ensure the dispersibility of the graphene and the uniform distribution of the graphene and the rare earth oxide in the plating layer. Further, in some embodiments, the concentration of the rare earth oxide is 0.36 to 2.4 g/L, for example, 0.36 g/L, 0.4 g/L, 0.5 g/L, 0.8 g/L, 1 g/L, 1.5 g/L, 2 g/L, 2.2 g/L, 2.4 g/L, or the like. In addition, in the composite plating solution, the concentration of the graphene may be 0.3 to 0.8 g/L. By controlling the ratio and the concentration of the graphene and the rare earth oxide in the plating solution, the migration rate of the graphene and the rare earth oxide in the plating solution during the electroplating is promoted, so that the graphene and the rare earth oxide migrate to the area to be plated rapidly and at a speed that matches each other, ensuring uniform distribution of the graphene and the rare earth oxide in the plating layer, ensuring that the graphene and the rare earth oxide in the plating layer fully exert a balance point of respective excellent properties, and improving properties such as hardness, welding resistance, wear resistance, and the like while ensuring electric conductivity.

In some embodiments, a particle size of the rare earth oxide is 10 to 120 nm, for example, 10 to 20 nm, 20 to 50 nm, 40 to 60 nm, 60 to 80 nm, 80 to 100 nm, 100 to 120 nm, or the like, which facilitates uniform distribution of the particles in the plating layer.

The addition of the wetting agent helps to reduce the surface tension of the graphene so that it combines with the dispersing agent, thereby improving the dispersibility of the graphene and avoiding agglomeration. Further, in some embodiments, the wetting agent includes at least two of 1,3,6-naphthalene trisulfonate sodium salt, lignosulfonate, or alkyl sulfosuccinate. Any two or more of the above species, when used in combination, can synergistically enhance the enhancement the performance and strengthen the effect of enhancing the dispersibility of the graphene. Specifically, the wetting agent used in the present technical solution includes at least two of the listed components, and is a compound wetting agent, which not only plays a wetting role on the graphene, but also improves the wettability of the surface of the graphene. Moreover, the synergistic effect of the two or more components in the compound wetting agent will play a role of re-stripping the agglomerated or multi-layer the graphene, so that not only the effect of dispersing the graphene is achieved, but also the effect of reducing the agglomeration of the graphene is achieved, with better dispersion and prolonged dispersion time.

The dispersing agent includes at least one of a naphthol sulfonic acid formalin condensate sodium salt, a naphthalene sulfonic acid formalin condensate sodium salt, a carboxylic acid-styrene sulfonic acid copolymer sodium salt, a sodium dialkyl sulfosuccinate, sodium lauryl sulfate, or a polyoxyethylene alkyl aryl ether. The addition of the dispersing agent in combination with the wetting agent helps to improve the dispersion of the graphene and the rare earth oxide in the plating solution.

In some embodiments, the concentration of the wetting agent is 0.3 to 2 g/L, for example, 0.3 g/L, 0.4 g/L, 0.5 g/L, 1 g/L, 1.5 g/L, 1.8 g/L, 2 g/L, or the like. In other embodiments, the concentration of the dispersing agent is 0.3 to 3.5 g/L, for example, 0.3 g/L, 0.4 g/L, 0.5 g/L, 1 g/L, 1.5 g/L, 1.8 g/L, 2 g/L, 3 g/L, 3.5 g/L, or the like. By controlling the concentration of the wetting agent and the dispersing agent, the dispersibility of each component in the plating solution is improved, and the stability of the plating solution is ensured while the silver ions, the rare earth oxide and the graphene have a high migration rate in the plating solution.

Further, in some embodiments, the weight ratio of the wetting agent to the dispersing agent is 1:1 to 2, for example, 1:1, 1:1.2, 1:1.3, 1:1.5, 1:1.7, 1:2, or the like, thus facilitating better coordination of the wetting agent and dispersing agent.

The cyanide may be selected from any one of cyanides generally used in the art, for example, at least one of potassium cyanide or sodium cyanide.

In some embodiments, the concentration of the cyanide is 90 to 210 g/L, for example, 90 g/L, 95 g/L, 100 g/L, 105 g/L, 110 g/L, 120 g/L, 130 g/L, 150 g/L, 160 g/L, 180 g/L, 200 g/L, 210 g/L, or the like. Further, in some embodiments, the cyanide is potassium cyanide with a concentration of 100 to 210 g/L in the composite plating solution.

Further, in some embodiments, the water-soluble silver-containing compound may include silver nitrate. In the composite plating solution, the concentration of the silver ions is 5 to 10 g/L, for example, 5 g/L, 6 g/L, 7 g/L, 8 g/L, 9 g/L, 10 g/L, or the like.

In some embodiments, the pH of the composite plating solution is 7.5 to 10.5, for example, 7.5, 8, 8.5, 9, 10, 10.5, or the like.

In an embodiments, the composite plating solution includes a water-soluble silver-containing compound, cyanide, the graphene, a rare earth oxide, a dispersing agent, a wetting agent, and water. The rare earth oxide includes at least one of lanthanum oxide, yttrium oxide, or cerium oxide.

Further, in another embodiment, the composite plating solution includes 5 to 10 g/L of the silver ions, 90 to 210 g/L of the cyanide, 0.3 to 0.8 g/L of the graphene, 0.36 to 2.4 g/L of the rare earth oxide, 0.3 to 3.5 g/L of the dispersing agent, 0.3 to 2 g/L of the wetting agent, and water. The rare earth oxide includes at least one of lanthanum oxide, yttrium oxide, or cerium oxide. The pH of the composite plating solution is 7.5 to 10.5. The weight ratio of the graphene to the rare earth oxide is 1:1.2 to 3.

Based on the above embodiments, the present disclosure further provides a method for preparing the composite plating solution, specifically including: adding the cyanide and the water-soluble silver-containing compound to a portion of water, and stirring and mixing to prepare a plating solution; adding the wetting agent to a portion of the water to form a wetting agent solution; adding the dispersing agent to the remaining water to prepare a dispersing agent solution; adding the wetting agent solution, the dispersing agent solution, the graphene, and the rare earth oxide sequentially to the plating solution with stirring, and adjusting pH to prepare the composite plating solution.

In addition, the present disclosure also provides a composite plating layer having a material including a rare earth oxide, graphene, and silver. The rare earth oxide includes at least one of lanthanum oxide, yttrium oxide, or cerium oxide.

The composite plating layer according to the present disclosure includes the rare earth oxide, the graphene, and the silver. The graphene has excellent properties such as high electric conductivity, high heat conductivity, high strength, high flexibility, strong chemical inertness, and the like, so that the addition of the graphene to the composite plating layer can improve the properties such as arc extinction, welding resistance, wear resistance, and hardness of the composite plating layer. In addition, the addition of the rare earth oxide helps to improve the welding resistance and hardness of the composite plating layer. In general, the composite plating layer has excellent electric conductivity, wear resistance, hardness, and welding resistance performance, and due to the addition of the graphene with high electric conductivity, the amount of silver is correspondingly reduced, thereby reducing the cost.

In some embodiments, a thickness of the composite plating layer is 25 to 40 μm.

In some embodiments, the weight ratio of the graphene to the rare earth oxide in the composite plating layer is 1:1.2 to 3.

In some embodiments, the rare earth oxide is a combination of yttrium oxide and lanthanum oxide in a weight ratio of 1:7 to 9. In other embodiments, the rare earth oxide is a combination of yttrium oxide and cerium oxide in a weight ratio of 1:6 to 8. In still other embodiments, the rare earth oxide is a combination of yttrium oxide, cerium oxide, and lanthanum oxide in a weight ratio of 1:1 to 1.5:5 to 8.

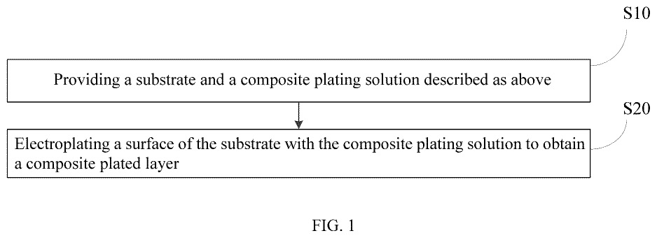

In addition, referring to FIG. 1, a method for preparing a composite plating layer according to the present disclosure includes the following steps:

Step S10: providing a substrate and a composite plating solution as described above;

Step S20: Electroplating a surface of the substrate with the composite plating solution to obtain the composite plating layer.

The substrate may be any substrate to be coated, and the material of the substrate may include, but is not limited to, at least one of copper, silver, gold, platinum, or an alloy thereof.

The composite plating solution includes the water-soluble silver-containing compound, the cyanide, the graphene, the rare earth oxide, the dispersing agent, the wetting agent, and water. The rare earth oxide includes at least one of lanthanum oxide, yttrium oxide, or cerium oxide.

In some embodiments, the temperature of the composite plating solution is 16 to 24 °C during the electroplating, for example, 16 °C, 17 °C, 18 °C, 19 °C, 20 °C, 22 °C, 24 °C, or the like. In other embodiments, the current density is 0.3 to 0.7 A/dm² during the electroplating, for example, 0.3 A/dm², 0.4 A/dm², 0.5 A/dm², 0.6 A/dm², 0.7 A/dm², or the like.

In addition, the present disclosure also provides an electric contact material including a substrate and a composite plating layer coated on a surface of the substrate. The composite plating layer includes the composite plating layer as described above. Alternatively, the composite plating layer is prepared by the method for preparing the composite plating layer as described above.

The technical solutions and technical effects of the present disclosure will be described in detail by means of specific examples, comparative examples, and experimental examples. The following examples are merely partial embodiments of the present disclosure, and do not specifically limit the present disclosure.

### Example 1

The composite plating solution includes silver nitrate, potassium cyanide, graphene, a rare earth oxide, a dispersing agent, a wetting agent, and water, wherein the concentration of silver ions is 8 g/L, the concentration of the graphene is 0.6 g/L, the concentration of the rare earth oxide is 1.2 g/L, the concentration of the wetting agent is 0.3 g/L, the concentration of the dispersing agent is 0.3 g/L, the concentration of potassium cyanide is 105 g/L. The pH of the composite plating solution is 8.5. The rare earth oxide is yttrium oxide and lanthanum oxide in a weight ratio of 1:8. The particle size of the rare earth oxide is in the range of 10 to 50 nm. The dispersing agent is a naphthol sulfonic acid formalin condensate sodium salt and a carboxylic acid-styrene sulfonic acid copolymer sodium salt in a weight ratio of 1:6. The wetting agent is a 1,3,6-naphthalene trisulfonate sodium salt, lignosulfonate and alkyl sulfosuccinate in a weight ratio of 7:2:1.

Preparation of the composite plating solution: water in three portions was provided. Potassium cyanide and silver nitrate were added to a portion of water, with stirring and mixing to prepare a plating solution. The wetting agent was added to a portion of the water to form a wetting agent solution. The dispersing agent was added to the remaining water to prepare a dispersing agent solution. The wetting agent solution, the dispersing agent solution, the graphene and the rare earth oxide were successively added to the plating solution while stirring, and the pH was adjusted to 8.5 to prepare the composite plating solution.

Preparation of an electric contact material: a copper sheet was provided, and placed in the composite plating solution prepared as described above, in which a current density was set to be 0.7 A/dm², and an plating temperature (temperature of the composite plating solution) was 20 °C, so as to perform electrodeposition to obtain a composite plating layer having a thickness of 30 μm.

### Example 2

This example is basically the same as Example 1, except that in this example:

The rare earth oxide was replaced to yttrium oxide and lanthanum oxide in a weight ratio of 1:7.

### Example 3

This example is basically the same as Example 1, except that in this example:

The rare earth oxide was replaced to yttrium oxide and lanthanum oxide in a weight ratio of 1:9.

### Example 4

This example is basically the same as Example 1, except that in this example:

The rare earth oxide was replaced to yttrium oxide and cerium oxide in a weight ratio of 1:6.

### Example 5

This example is basically the same as Example 1, except that in this example:

The rare earth oxide was replaced to yttrium oxide and cerium oxide in a weight ratio of 1:7.

### Example 6

This example is basically the same as Example 1, except that in this example:

The rare earth oxide was replaced to yttrium oxide and cerium oxide in a weight ratio of 1:8.

### Example 7

This example is basically the same as Example 1, except that in this example:

The rare earth oxide was replaced to yttrium oxide, cerium oxide, and lanthanum oxide in a weight ratio of 1:1:5.

### Example 8

This example is basically the same as Example 1, except that in this example:

The rare earth oxide was replaced to yttrium oxide, cerium oxide, and lanthanum oxide in a weight ratio of 1:1.2:6.

### Example 9

This example is basically the same as Example 1, except that in this example:

The rare earth oxide was replaced to yttrium oxide, cerium oxide, and lanthanum oxide in a weight ratio of 1:1.5:8.

### Example 10

This example is basically the same as Example 1, except that in this example:

The rare earth oxide was replaced to cerium oxide and lanthanum oxide in a weight ratio of 1:7.

### Example 11

This example is basically the same as Example 1, except that in this example:

The concentration of graphene was changed from 0.6 g/L to 0.8 g/L, and the concentration of the rare earth oxide was changed from 1.2 g/L to 2.4 g/L.

### Example 12

This example is basically the same as Example 1, except that in this example:

The concentration of graphene was changed from 0.6 g/L to 0.3 g/L, and the concentration of the rare earth oxide was changed from 1.2 g/L to 0.36 g/L.

### Example 13

This example is basically the same as Example 1, except that in this example:

The wetting agent was replaced to a combination of 1,3,6-naphthalene trisulfonate sodium salt and sodium dodecyl benzenesulfonate in a weight ratio of 1:1.

### Example 14

This example is basically the same as Example 1, except that in this example:

The wetting agent was replaced to a composition of sodium dodecyl benzenesulfonate and lignosulfonate in a weight ratio of 2:1, and the dispersing agent was replaced to naphthalene sulfonic acid formalin condensate sodium salt.

### Example 15

This example is basically the same as Example 1, except that in this example:
the concentration of the wetting agent was changed from 0.3 g/L to 1 g/L, the concentration of the dispersing agent was changed from 0.3 g/L to 2 g/L, and the dispersing agent was replaced to a composition of sodium dialkyl sulfosuccinate, sodium lauryl sulfate, and polyoxyethylene alkyl aryl ether in a weight ratio of 1:1:1.

### Example 16

This example is basically the same as Example 1, except that in this example:

The concentration of the wetting agent was changed from 0.3 g/L to 2 g/L, and the concentration of the dispersing agent was changed from 0.3 g/L to 3.5 g/L.

### Example 17

This example is basically the same as Example 1, except that in this example:
the concentration of the silver ions was changed from 8 g/L to 5 g/L, the pH of the composite plating solution was changed from 8.5 to 7.5, and in preparing the electric contact material, the current density was changed from 0.7 A/dm² to 0.3 A/dm², the plating temperature (temperature of the composite plating solution) was changed from 20 °C to 16 °C, and the thickness of the composite plating layer was changed from 30 μm to 25 μm

### Example 18

This example is basically the same as Example 1, except that in this example:

The concentration of potassium cyanide was changed from 105 g/L to 210 g/L, the concentration of the silver ions was changed from 8 g/L to 10 g/L, the pH of the composite plating solution was changed from 8.5 to 10.5, and in preparing the electric contact material, the plating temperature (temperature of the composite plating solution) was changed from 20 °C to 24 °C, and the thickness of the composite plating layer was changed from 30 μm to 40 μm

### Example 19

This example is basically the same as Example 1, except that in this example:
the composite plating solution includes silver nitrate, potassium cyanide, graphene, a rare earth oxide, a dispersing agent, a wetting agent, and water, wherein the concentration of the silver ions is 7 g/L, the concentration of the graphene is 0.3 g/L, the concentration of the rare earth oxide is 0.8 g/L, the concentration of the wetting agent is 0.3 g/L, the concentration of the dispersing agent is 0.3 g/L, and the concentration of potassium cyanide is 100 g/L. The pH of the composite plating solution is 8.5. The rare earth oxide is lanthanum oxide. The particle size of the rare earth oxide is in the range of 100 to 120 nm. The dispersing agent is a naphthol sulfonic acid formalin condensate sodium salt and carboxylic acid-styrene sulfonic acid copolymer sodium salt in a weight ratio of 1:6. The wetting agent is 1,3,6-naphthalene trisulfonate sodium salt, lignosulfonate and alkyl sulfosuccinate in a weight ratio of 7:2:1.

Preparation of the composite plating solution: water in three portions was provided. Potassium cyanide and silver nitrate were added to a portion of water, with stirring and mixing to prepare a plating solution. The wetting agent was added to a portion of the water to form a wetting agent solution. The dispersing agent was added to the remaining water to prepare a dispersing agent solution. The wetting agent solution, the dispersing agent solution, the graphene and the rare earth oxide were successively added to the plating solution while stirring, and the pH was adjusted to 8.5 to prepare the composite plating solution.

Preparation of the electric contact material: a copper sheet was provided, and placed in the composite plating solution prepared as described above. The current density was set to be 0.6 A/dm², and the plating temperature (temperature of the composite plating solution) was 20 °C, so as to perform electrodeposition to obtain the composite plating layer having a thickness of 28 μm.

### Comparative Example 1

This comparative example is substantially the same as Example 1, except that in this comparative example:

The rare earth oxide is removed, and the other components are unchanged.

### Comparative Example 2

This comparative example is substantially the same as Example 1, except that in this comparative example:

The rare earth oxide was replaced to yttrium oxide, cerium oxide and lanthanum oxide in a weight ratio of 1:1:9.

### Comparative Example 3

This comparative example is substantially the same as Example 1, except that in this comparative example:

The rare earth oxide was replaced to yttrium oxide, cerium oxide, and lanthanum oxide in a weight ratio of 1:2:4.

### Comparative Example 4

This comparative example is substantially the same as Example 1, except that in this comparative example:

The rare earth oxide is replaced to yttrium oxide and cerium oxide in a weight ratio of 1:9.

### Comparative Example 5

This comparative example is substantially the same as Example 1, except that in this comparative example:

The rare earth oxide was replaced to yttrium oxide, cerium oxide, and scandium oxide in a weight ratio of 1:1:5.

### Comparative Example 6

This comparative example is substantially the same as Example 1, except that in this comparative example:

The rare earth oxide was replaced to scandium oxide.

### Comparative Example 7

This comparative example is substantially the same as Example 1, except that in this comparative example:

The dispersing agent was replaced to sodium dodecyl sulfate.

### Comparative Example 8

This comparative example is substantially the same as Example 1, except that in this comparative example:

The wetting agent was replaced to 1,3,6-naphthalene trisulfonic acid sodium salt.

### Comparative Example 9

This comparative example is substantially the same as Example 1, except that in this comparative example:

The wetting agent was removed, and the other components were unchanged.

### Comparative Example 10

This comparative example is substantially the same as Example 1, except that in this comparative example:

The dispersing agent was removed, and the other components were unchanged.

### Comparative Example 11

This comparative example is substantially the same as Example 1, except that in this comparative example:

The dispersing agent was replaced to byk-110, and the other components were unchanged.

### Comparative Example 12

This comparative example is substantially the same as Example 1, except that in this comparative example:

The concentration of the rare earth oxide was changed from 1.2 g/L to 3 g/L.

### Comparative Example 13

This comparative example is substantially the same as Example 1, except that in this comparative example:

The graphene was removed, and the other components were unchanged.

### Comparative Example 14

This comparative example is substantially the same as Example 1, except that in this comparative example:

The graphene, the rare earth oxide, the dispersing agents and the wetting agent were removed.

### Experimental Example 1

The zeta potential of the composite plating solution obtained in Examples 1 to 18 and Comparative Examples 2 to 11 was measured, and the absolute value of the measured zeta potential was recorded in Table 1.

TABLE I

| | Zeta potential/mV |
|---|---|
| Example 1 | 48.8 |
| Example 2 | 48.2 |
| Example 3 | 48 |
| Example 4 | 47.2 |
| Example 5 | 47.9 |
| Example 6 | 48 |
| Example 7 | 46.5 |
| Example 8 | 46.9 |
| Example 9 | 45.9 |
| Example 10 | 47.5 |
| Example 11 | 49.1 |
| Example 12 | 49 |
| Example 13 | 48.2 |
| Example 14 | 48.5 |
| Example 15 | 48.5 |
| Example 16 | 48.7 |
| Example 17 | 48.5 |
| Example 18 | 48.6 |
| Example 19 | 49.6 |
| Comparative | 31.6 |
| Example 2 | |
| Comparative | 30.9 |
| Example 3 | |
| Comparative | 35.9 |
| Example 4 | |
| Comparative | 33 |
| Example 5 | |
| Comparative | 37.2 |
| Example 6 | |
| Comparative | 39.2 |
| Example 7 | |
| Comparative | 41 |
| Example 8 | |
| Comparative | 28.4 |
| Example 9 | |
| Comparative | 22.5 |
| Example 10 | |
| Comparative | 34.9 |
| Example 11 | |
| Comparative | 39.3 |
| Example 12 | |

As can be seen from Table I:

Compared to the Comparative Examples 2 to 6, each of the Examples has a higher absolute value of zeta potential, indicating that the composite plating solution prepared in the Examples has better dispersibility and stability, and that the present disclosure can ensure compatibility of all components in the plating solution and stability of the plating solution by adding at least one of yttrium oxide, cerium oxide or lanthanum oxide as the rare earth oxide to the composite plating solution in a specific proportion. Further, Example 1 has a higher dispersibility than Comparative Example 12, indicating that the addition of the rare earth oxide in the weight ratio 1:1.2 to 3 of the graphene to the rare earth oxide helps to improve the dispersibility of the materials in the plating solution.

Compared to the Comparative Examples 7 to 11, each of the Examples has a higher absolute value of zeta potential, indicating that the composite plating solutions prepared in the Examples has better dispersibility and stability, and that by selecting a combination of specific dispersing agents and wetting agents, the present disclosure can play a good synergistic role among different dispersing agents or among dispersing agents and wetting agents, thereby contributing to improving the dispersibility and stability of the plating solution.

### Experimental Example 2

The properties of the composite plating layers prepared in Examples 1 to 19 and Comparative Examples 1 and 12 to 14 were tested for wear resistance, welding resistance, and hardness of the composite plating layers, and the results were recorded in Table 2.

TABLE 2

| | Fusion welding (g) | Hardness (HV) | Wear Resistance (time/μm) |
|---|---|---|---|
| Example 1 | 3.77 | 116 | 1955 |
| Example 2 | 3.82 | 116 | 1934 |
| Example 3 | 3.87 | 114 | 1950 |
| Example 4 | 3.82 | 110 | 1890 |
| Example 5 | 3.97 | 112 | 1882 |
| Example 6 | 4.02 | 109 | 1891 |
| Example 7 | 3.79 | 114 | 1919 |
| Example 8 | 3.92 | 112 | 1923 |
| Example 9 | 3.85 | 115 | 1934 |
| Example 10 | 4.76 | 108 | 1876 |
| Example 11 | 3.79 | 116 | 1951 |
| Example 12 | 3.79 | 117 | 1949 |
| Example 13 | 3.82 | 116 | 1953 |
| Example 14 | 3.78 | 112 | 1954 |
| Example 15 | 3.77 | 115 | 1957 |
| Example 16 | 3.77 | 119 | 1955 |
| Example 17 | 3.91 | 111 | 1945 |
| Example 18 | 3.86 | 113 | 1938 |
| Example 19 | 4.23 | 102 | 1852 |
| Comparative Example 1 | 7.11 | 96 | 1818 |
| Comparative Example 12 | 5.01 | 101 | 1848 |
| Comparative Example 13 | 6.89 | 98 | 1833 |
| Comparative Example 14 | 11.01 | 90 | / |

As can be seen from Table 2:

Compared to Comparative Examples 1, 13 and 14, the composite plating layers prepared in Examples 1 to 19 show higher hardness, wear resistance and welding resistance, indicating that the composite plating solutions provided in the present disclosure improve the hardness, wear resistance and welding resistance of the plating layer by adding both of the graphene and the rare earth oxide.

According to Examples 1 to 10 and 19, the composite plating layers prepared in Examples 1 to 3 have higher hardness, wear resistance and welding resistance, indicating that the addition of yttrium oxide and lanthanum oxide as the rare earth oxide in the composite plating solution according to the present disclosure not only ensures the compatibility of all components in the plating solution, but also ensures the stability of the plating solution, and can effectively improve the hardness, wear resistance and welding resistance of the plating layer.

As can be seen from Example 1 and Comparative Example 12, the hardness, wear resistance, and welding resistance of the plating layer in Example 1 are superior to those of Comparative Example 12, indicating that not only the stability of the plating solution can be improved, but also the overall performance of the plating layer can be improved by controlling the rare earth oxide in the range of 0.36 to 2.4 g/L.

The present disclosure has been described in detail with respect to the composite plating solution, the method for preparing the composite plating layer, and the electric contact material according to the embodiments of the present disclosure. Specific examples are used to describe the principles and Implementations of the present disclosure. The description of the above embodiments is merely provided to help understand the method of the present disclosure and the core idea thereof. Variations may be made to those skilled in the art in both the detailed description and the scope of disclosure in accordance with the teachings of the present disclosure. In view of the foregoing, the present description should not be construed as limiting the disclosure.

1. A composite plating solution comprising a water-soluble silver-containing compound, a cyanide, graphene, a rare earth oxide, a dispersing agent, a wetting agent, and water, wherein the rare earth oxide comprises at least one of lanthanum oxide, yttrium oxide, or cerium oxide.

2. The composite plating solution according to claim 1, wherein a weight ratio of the graphene to the rare earth oxide is 1:1.2 to 3.

3. The composite plating solution according to claim 1, wherein the rare earth oxide has a particle size of 10 to 120 nm.

4. The composite plating solution according to claim 1, wherein the rare earth oxide comprises yttrium oxide and lanthanum oxide in a weight ratio of 1:7 to 9.

5. The composite plating solution according to claim 1, wherein the rare earth oxide comprises yttrium oxide and cerium oxide in a weight ratio of 1:6 to 8.

6. The composite plating solution according to claim 1, wherein the rare earth oxide comprises yttrium oxide, cerium oxide and lanthanum oxide in a weight ratio of 1:1 to 1.5:5 to 8.

7. The composite plating solution according to claim 1, wherein the wetting agent comprises at least two of 1,3,6-naphthalene trisulfonate sodium salt, lignosulfonate, or alkyl sulfosuccinate.

8. The composite plating solution according to claim 1, wherein the dispersing agent comprises at least one of a naphthol sulfonic acid formalin condensate sodium salt, a naphthalene sulfonic acid formalin condensate sodium salt, a carboxylic acid-styrene sulfonic acid copolymer sodium salt, sodium dialkyl sulfosuccinate, sodium lauryl sulfate, a polyoxyethylene alkyl aryl ether.

9. The composite plating solution according to claim 1, wherein a concentration of silver ions of the silver-containing compound in the composite plating solution is 5 to 10 g/L.

10. The composite plating solution according to claim 1, wherein a concentration of the graphene in the composite plating solution is 0.3 to 0.8 g/L.

11. The composite plating solution according to claim 1, wherein a concentration of the rare earth oxide in the composite plating solution is 0.36 to 2.4 g/L.

12. The composite plating solution according to claim 1, wherein a concentration of the dispersing agent in the composite plating solution is 0.3 to 3.5 g/L.

13. The composite plating solution according to claim 1, wherein a concentration of the cyanide in the composite plating solution is 90 to 210 g/L; and/or,
the cyanide comprises at least one of potassium cyanide or sodium cyanide.

14. The composite plating solution according to claim 1, wherein a concentration of the wetting agent in the composite plating solution is 0.3 to 2 g/L; and/or,
a pH of the composite plating solution is 7.5 to 10.5.

15. The composite plating solution according to claim 1, wherein a weight ratio of the wetting agent to the dispersing agent in the composite plating solution is 1:1 to 2.

16. The composite plating solution according to claim 1, wherein the composite plating solution is composed of the water-soluble silver-containing compound, the cyanide, the graphene, the rare earth oxide, the dispersing agent, the wetting agent, and water, and the rare earth oxide is composed of at least one of lanthanum oxide, yttrium oxide, or cerium oxide; and/or,
in the composite plating solution, the concentration of the silver ions is 5 to 10 g/L, the concentration of the graphene is 0.3 to 0.8 g/L, the concentration of the rare earth oxide is 0.36 to 2.4 g/L, the concentration of the wetting agent is 0.3 to 2 g/L, the concentration of the dispersing agent is 0.3 to 3.5 g/L, the concentration of the cyanide is 90 to 210 g/L; the pH of the composite plating solution is 7.5 to 10.5; and the weight ratio of the graphene to the rare earth oxide is 1:1.2 to 3.

17. A method for preparing a composite plating layer, comprising:
providing a substrate and a composite plating solution and
electroplating a surface of the substrate with the composite plating solution to obtain a composite plating layer,
wherein the composite plating solution comprises a water-soluble silver-containing compound, a cyanide, graphene, a rare earth oxide, a dispersing agent, a wetting agent, and water, and the rare earth oxide comprises at least one of lanthanum oxide, yttrium oxide, or cerium oxide.

18. The method according to claim 17, wherein a temperature of the composite plating solution during the electroplating is 16 to 24 °C.

19. The method according to claim 17, wherein a current density during the electroplating is 0.3 to 0.7 A/dm².

20. An electric contact material comprising a substrate and a composite plating layer applied on a surface of the substrate, the composite plating layer being prepared by a method comprising
providing a substrate and a composite plating solution and
electroplating a surface of the substrate with the composite plating solution to obtain a composite plating layer,
wherein the composite plating solution comprises a water-soluble silver-containing compound, a cyanide, graphene, a rare earth oxide, a dispersing agent, a wetting agent, and water, and the rare earth oxide comprises at least one of lanthanum oxide, yttrium oxide, or cerium oxide.
